(19) United States
(12) Patent Application Publication
(10) Pub. No.: US 2017/0129054 A1
(43) Pub. Date: May 11, 2017

(54) RUST FREE STAINLESS STEEL ENGRAVING

(71) Applicant: nLIGHT, Inc., Vancouver, WA (US)

(72) Inventor: Adam Dittli, Vancouver, WA (US)

(73) Assignee: nLIGHT, Inc., Vancouver, WA (US)

(21) Appl. No.: 15/349,174

(22) Filed: Nov. 11, 2016

Related U.S. Application Data
(60) Provisional application No. 62/253,873, filed on Nov. 11, 2015.

(51) Int. Cl. B23K 26/352; B23K 26/00

(52) U.S. Cl. CPC B23K 26/352; B23K 26/0006; B23K 2203/05

(57) ABSTRACT

A method includes generating at least one laser passivation pulse with process parameters selected to passivate an area of a metal target, and directing the at least one laser passivation pulse to the area in order to produce a passivation layer. Another method further includes, prior to laser passivation, generating at least one laser ablation pulse with process parameters selected to ablate metal from the area of the target, and directing the at least one laser ablation pulse to the area so as to ablate the metal and to provide the area for laser passivation.

### CROSS REFERENCE TO RELATED APPLICATION

This application claims the benefit of U.S. Provisional Patent Application No. 62/253,873, filed Nov. 11, 2015, which is incorporated by reference herein in its entirety.

### FIELD

The field is laser engraving and passivation of stainless steel.

### BACKGROUND

Stainless steel exhibits a list of superior material attributes which set it apart from other materials and lend its use to a variety of applications. The term “stainless steel” can be generic to a variety of steel alloys, though each alloy is typically made mostly of iron and includes at least 10.5% chromium. Nickel, molybdenum, nitrogen, titanium, and copper are also common components of stainless steel alloys. However, chromium, and particularly chromium oxide, which forms on the exposed surface of a stainless steel object, imparts the object with a corrosion resistance that is highly sought after. In addition to corrosion resistance, compared to iron on other iron alloys, stainless steels can have superior yield strength, elastic modulus, ductility, and other attributes as well.

The corrosion resistant surface layer is known as a passivation layer and different alloys have different degrees of corrosion resistance associated with this layer depending on the alloy composition, the metallurgical formation, and the crystalline structure of the metal. The passivation layer can form naturally to some extent merely by exposing the object's surface to an oxygen rich environment, providing many stainless steel surfaces with ‘self-healing’ characteristics when knicked or scratched. Often, it is desirable that the passivation layer be enhanced beyond what is provided by such a native oxide layer or that the layer be directly grown on the surfaces of a machined part. For example, conventional laser based techniques for engraving metals achieve a desirable engraving depth and appearance but the process completely removes the corrosion resistance passivation layer.

In order to grow or regrow the passivation layer with greater control, the desired surface of the object is typically chemically processed with one or more passivation treatments. The most common treatments involve controlled submersion in a chemical bath of nitric acid or citric acid, which removes free iron from the surface so that the iron is not available to rust. Electropolishing is another technique requiring immersion in a chemical bath. The surface of object is exposed to a sulfuric acid or phosphoric acid in an electrolytic configuration so that the surface, operating as an anode, delivers free surface iron into the acidic solution with the passage of current to a cathode. In addition to being environmentally problematic, chemical etch processes typically have a narrow process window and require constant monitoring or adjustment, leading to considerable capital costs and protracted manufacturing process times.

For various other reasons, it is generally desirable for additional passivation treatment options to be available or that the reliance on the current caustic, chemical-based approaches be reduced or eliminated. As medical devices becomes smaller and more technologically advanced, a need for speedier and more surgically appropriate methods of fabricating, machining, and engraving stainless steel parts remains. Consumer electronic devices, such as smartphones and the like, often implement structural and aesthetic stainless steel components into an assembled design, making in situ chemical repassivation of a selected surface difficult or impossible when the surface adjoins an electronically sensitive component. Accordingly, improved stainless steel engraving and passivation methods are necessary.

### SUMMARY

According to one aspect, a method includes generating at least one laser passivation pulse with process parameters selected to passivate an area of a metal target, and directing the at least one laser passivation pulse to the area in order to produce a passivation layer. Another method further includes, prior to such laser passivation, generating at least one laser ablation pulse with process parameters selected to ablate metal from the area of the target, and directing the at least one laser ablation pulse to the area so as to ablate the metal and to provide the area for laser passivation.

According to another aspect, a method includes generating at least one laser ablation pulse with process parameters selected to remove stainless steel, directing the at least one laser ablation pulse to an area of a target surface, generating at least one laser repassivation pulse with process parameters selected to repassivate the area of the target surface where stainless steel is removed by the at least one laser ablation pulse so as to inhibit corrosion on the area of the target surface, and directing the at least one laser repassivation pulse to the area of the target surface.

According to another aspect, an apparatus includes a pulsed fiber laser situated to generate stainless steel laser ablation process pulses in an ablation mode and generates stainless steel laser repassivation process pulses in a repassivation mode, the pulsed fiber laser including, a seed laser, an active fiber situated to receive optical pulses from the seed laser, a pump source coupled to the active fiber so as to deliver pump optical radiation to the active fiber to produce optical gain, and a pulse controller coupled to the seed laser and pump source to switch laser process parameters corresponding to the ablation or repassivation modes.

According to a further aspect, an object produced by the method of stainless steel ablation and passivation includes a stainless steel bulk layer having laser ablated surface features, and a laser repassivation layer situated on the laser ablated surface features.

The foregoing and other objects, features, and advantages will become more apparent from the following detailed description, which proceeds with reference to the accompanying figures.

### BRIEF DESCRIPTION OF THE DRAWINGS

FIG. 1 is a flowchart of a method for laser passivating a machined surface.

FIG. 2 is a flowchart of a method for laser ablating and laser repassivating a stainless steel target.

FIG. 3 is a flowchart of a method for laser ablating, laser repassivating, and chemically repassivating a stainless steel target.

FIGS. 4A-4B is a flowchart schematic of a method of ablating and repassivating a stainless steel target with the target shown in cross-section.

FIG. 5 is a schematic of a laser system configured to ablate and repassivate a metal target.

FIG. 6 is an image of stainless steel target samples that were ablated with the laser system of FIG. 5 and repassivated with the same laser system.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations of such aspects and features, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

As used herein, optical radiation refers to electromagnetic radiation at wavelengths of between about 100 nm and 10 μm, and typically between about 500 nm and 2 μm. Examples based on available laser diode sources and optical fibers generally are associated with wavelengths of between about 800 nm and 1700 nm, and more typically around 1 μm. In some examples, propagating optical radiation is referred to as one or more beams having diameters, beam cross-sectional areas, and beam divergences that can depend on beam wavelength and the optical systems used for beam shaping or beam delivery. For convenience, optical radiation is referred to as light in some examples, and need not be at visible wavelengths.

Representative embodiments are described with reference to optical fibers, but other types of optical waveguides can be used having square, rectangular, polygonal, oval, elliptical or other cross-sections. Optical fibers are typically formed of silica (glass) that is doped (or undoped) so as to provide predetermined refractive indices or refractive index differences. In some, examples, fibers or other waveguides are made of other materials such as fluorozirconates, fluoroaluminates, fluoride or phosphate glasses, chalcogenide glasses, or crystalline materials such as sapphire, depending on wavelengths of interest. Refractive indices of silica and fluoride glasses are typically about 1.5, but refractive indices of other materials such as chalcogenides can be 3 or more. In still other examples, optical fibers can be formed in part of plastics. In typical examples, a doped waveguide core, such as a fiber core, provides optical gain in response to pumping, and core and claddings are approximately concentric. In other examples, one or more of the core and claddings are decentered, and in some examples, core and cladding orientation and/or displacement vary along a waveguide length. In still further examples, satellite cores are helically wound around central cores, such as with chirally coupled core fiber.

In the examples disclosed herein, a waveguide core such as an optical fiber core is doped with a rare earth element such as Nd, Yb, Ho, Er, or other active dopants or combinations of dopants. Such actively doped cores can provide optical gain in response to optical or other pumping. As disclosed below, waveguides having such active dopants are generally referred to as active fibers of pulsed fiber laser systems. Such active fibers are typically disposed in amplifier or oscillator configurations. Optical pump radiation can be arranged to co-propagate and/or counter-propagate in the waveguide with respect to a propagation direction of an emitted laser beam or an amplified beam.

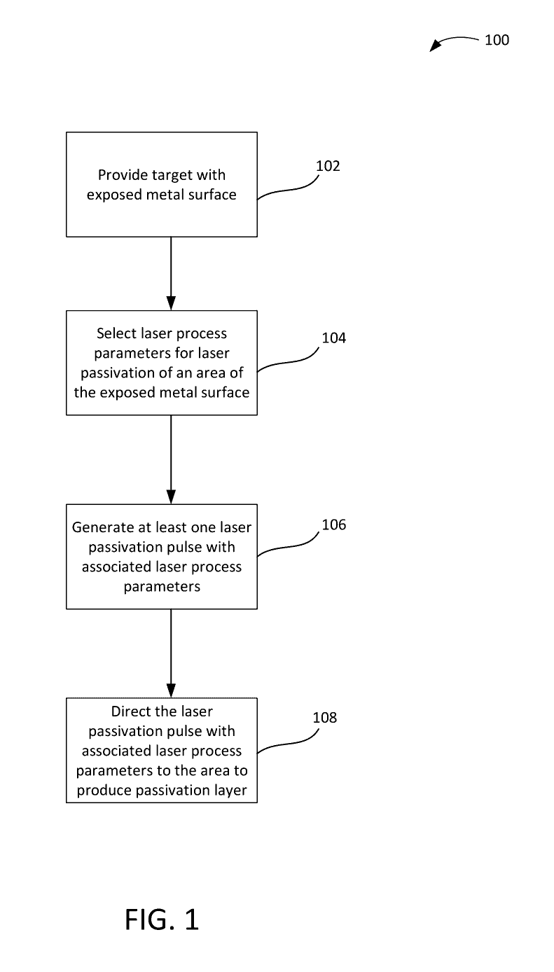

Referring to FIG. 1, a method 100 includes at 102, providing a target with an exposed metal surface. The target has typically been machined in a way which removes material to expose the metal surface, such as through a variety of machining techniques, including laser ablation. Often, in the process of removing material to expose the metal surface, a top passivation layer associated with the target is completely destroyed. At 104, laser passivation process parameters for a pulsed fiber laser system are selected for creating a new passivation layer or enhancing an existing one on a selected area of the exposed metal surface. At 106, laser passivation pulses associated with the selected laser process parameters are generated by the pulsed fiber laser system. At 108, the laser passivation pulses are directed to the exposed metal surface in accordance with the selected laser process parameters in order to produce the laser-based passivation characteristics on the area. In representative examples, the target and exposed metal surface are made of a stainless steel alloy. In particular examples, areas of an exposed stainless steel surface were exposed via laser ablation by a pulse fiber laser system. After material removal, suitable corrosion-resistant stainless steel passivation layers were made with three scan passes of 50 ps laser pulse bursts directed to the target at a pulse burst repetition frequency of 200 kHz. Each laser pulse burst had five pulses with an intra pulse burst frequency of 50 MHz. The average power of the beam of passivation pulses was about 1.2 W and the beam of pulses was scanned at about 4 m/s for each of the three scan passes. It will be appreciated that laser passivation process parameters can be varied to achieve different laser passivation results, including for surfaces of different material composition or with different machined characteristics.

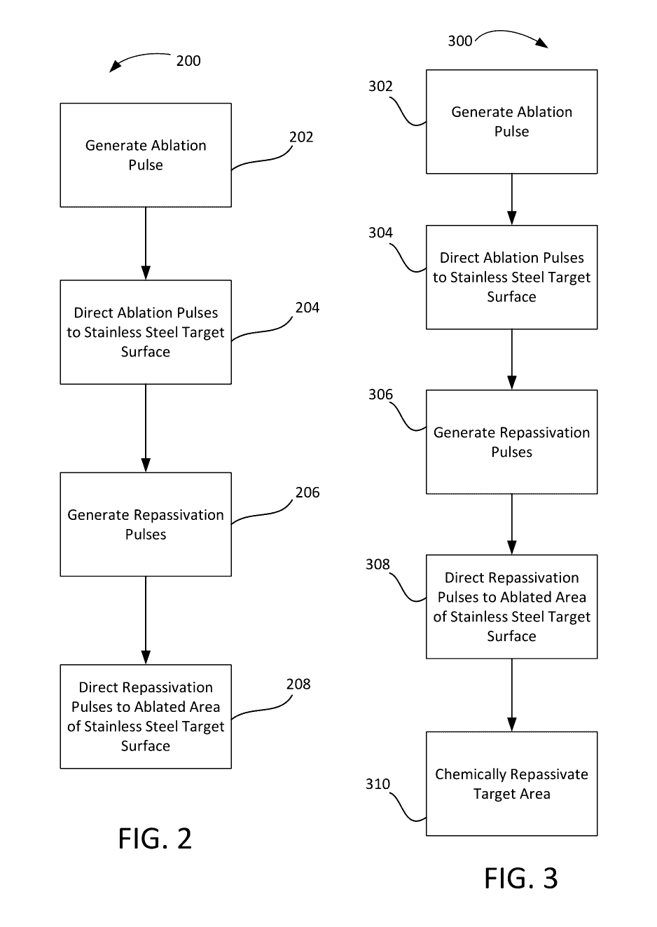

FIG. 2 is a flowchart of a method 200 for stainless steel processing. At 202, a pulsed fiber laser system generates at least one laser ablation pulse. In representative examples, the parameters of the laser pulse and of the scanning of multiple laser pulses are selected so as to ablatively remove stainless steel to an engraving depth. At 204, the laser ablation pulse is directed to a stainless steel target in order to process the surface of the target. Such processing includes engraving, drilling, cutting, marking, etc. Laser ablation pulse and ablation pulse processing parameters generally include pulse power, pulse duration, average power, peak power, pulse fluence, scan speed, pulse repetition frequency, pulse to pulse overlap, quantity of pulse scan passes, and ablation depth. One or more parameters can be determined from or depend upon other selected parameters. For example, some pulse overlaps can be calculated by multiplying scan speed and pulse repetition period. Engraving depth associated with a pulse can be increased with higher pulse energy or increased number of pulse scan passes. Different material effects are typically observed according to pulse duration. For example, ablation pulses in the femtosecond and picosecond range of pulse durations tend to remove material more cleanly than in the multi-nanosecond or microsecond range of pulse durations.

When a plurality of the laser ablation pulses are generated at 202, the pulses are directed at 204 by scanning the pulses across the target to create a predetermined pattern composed of lines, shapes, areas, and other features. After the desired pattern has been created, at 206, the pulsed fiber laser system generates at least one laser repassivation pulse. At 208, the laser repassivation pulse is directed to the surface of the target ablated at 204 in order to repassivate the surface. For unprocessed stainless steel, a thin passivation layer, which can be on the order angstroms or nanometers thick, typically covers the material surface and provides the corrosion resistance to the material. This protective passivation layer is often destroyed during the laser ablation process as both bulk stainless steel and the thin passivation layer covering the bulk material are ablated away by the incident laser ablation pulse.

Laser repassivation pulses typically have pulse and pulse processing parameters different from the aforementioned laser ablation pulses. In representative examples, many laser repassivation process parameters are conveniently selected to be approximately the same as laser ablation process parameters, but laser pulse power is decreased for repassivation. In this manner, the same laser system can be used to generate both laser ablation and laser repassivation pulses with few laser process or laser system alterations, minimizing tooling expense and reducing process time (or takt time) and laser system and process complexity. By applying the repassivation pulse, the thin passivation layer is reformed on the laser processed surface or the laser processed surface is otherwise transformed from a corrosion-sensitive state to a state which exhibits corrosion-resistant or corrosion-free properties associated with a thin passivation layer. Conventional chemical etching techniques are typically used to repassivate the material surface after ablation has removed material from the target surface. By repassivating the material surface with laser pulses, for many applications such conventional chemical processing techniques can be avoided altogether.

In further examples, a chemical processing step is applied to the material surface after repassivation pulses are applied. In FIG. 3, a method 300 includes, at 302, generating at least one laser ablation pulse with pulse and system parameters selected for laser ablation of a surface of a stainless steel object. At 304, the pulse is directed to the stainless steel object in order to engrave the surface of the stainless steel object with selected geometric characteristics, including surface pattern and surface depth. At 306, laser repassivation pulses are generated with pulse and system parameters selected to reproduce a repassivation effect when the pulse is applied to the surface of the stainless steel object which was ablated at 304. At 308, the surface is repassivated with at least one of such repassivation pulses. At 310, the laser pulse ablated repassivated surface is chemically processed to enhance the passivation characteristics applied at 308. In the absence of the repassivation pulse processing, the material surface repassivated with the chemical process may not exhibit superior anti-corrosion characteristics obtained by combining both laser and chemical repassivation processes. In additional examples, the sequence of laser pulse repassivation and chemical repassivation can be changed or applied multiple times for desired effect. Laser process parameters can be selected to adjust the stoichiometry at the material surface in order to improve passivation layer characteristics. Since the target surface receives laser repassivation pulses, other chemical repassivation options may be possible, making less hazardous or caustic chemical options, such as citric acid, more viable.

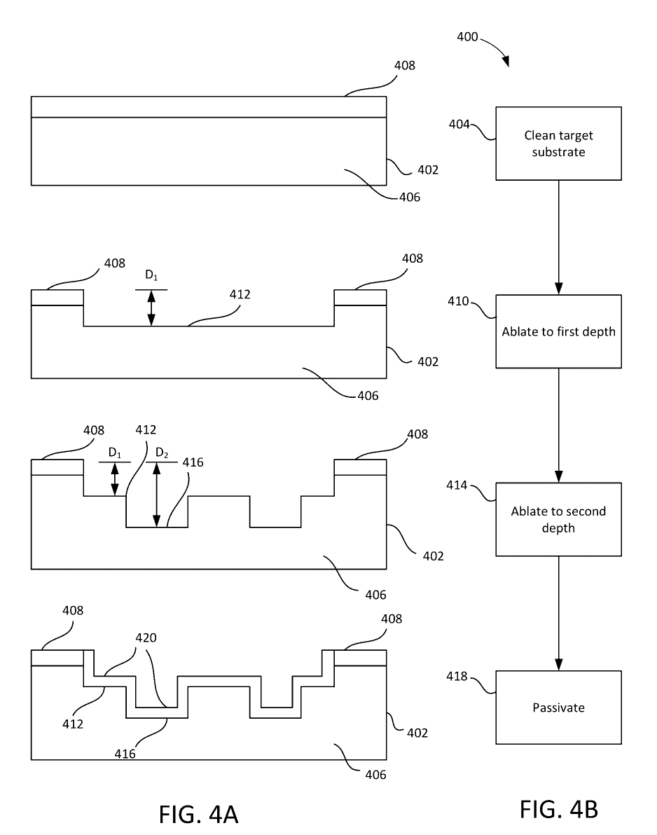

In FIGS. 4A-4B, a method 400 is shown in relation to side cross-sectional views of a stainless steel target 402 processed in accordance with the method 400. At 404, the target 402 is cleaned and situated to receive laser ablation pulses generated by a pulsed fiber laser. The laser ablation pulses are selected to remove portions of stainless steel bulk material 406 of the target 402 as well as portions of a passivation layer 408 disposed on the exposed surface of the target 402. At 410, the target 402 is ablated with the laser ablation pulses to an ablation depth D₁ to expose an ablated surface 412. In representative examples, ablation depths are controlled by selection of laser process parameters such as pulse power, pulse fluence, pulse repetition frequency, scan speed, and number of process scan passes. In some examples, single pass ablation depths are in the range of 1 μm to 10 μm using 50 ps pulses. At 414, a second set of one or more laser ablation pulses is delivered to the target 402 in a selected area providing a second exposed ablated surface 416 at an increased ablation depth D₂. In other examples, ablation depths can penetrate through the target 402 to form one or more holes. To reform a passivation layer on the exposed surfaces 412, 416, the laser system which generated the laser ablation pulses is configured to generate laser repassivation pulses for delivery to selected unpassivated areas corresponding to the exposed surfaces 412, 416 of the target 402. At 418, at least one set of one or more laser repassivation pulses is directed and delivered to the target 402 on the exposed surfaces 412, 416 in order to form a passivation layer 420.

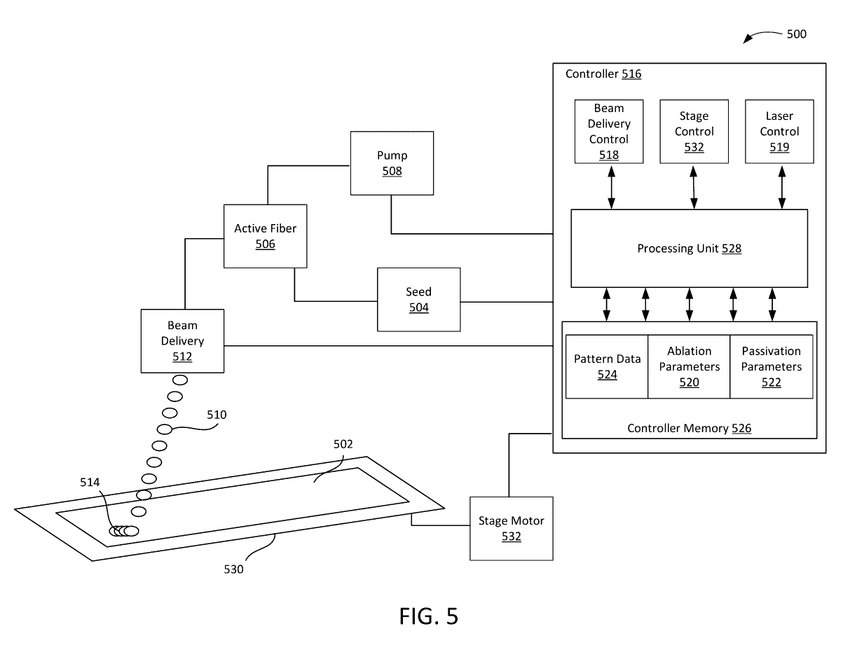

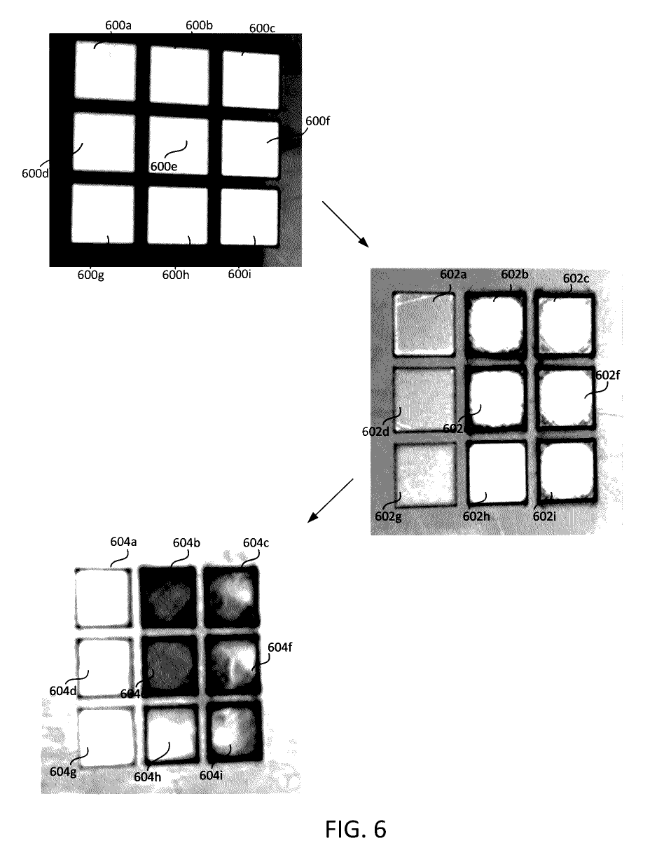

FIG. 5 is a schematic of a laser system 500 situated to laser process a corrosion resistant material target 502 such as stainless steel. The laser system 500 includes a seed laser 504 coupled to an active fiber 506 which is pumped by a pump source 508. The active fiber 506 generates amplified laser pulses 510 which are directed to a beam delivery system 512 such as a galvo-scanner. The galvo-scanner directs the laser pulses 510 to a surface 514 of the corrosion resistant material target 502. The laser pulses 510 can be configured for removing material, i.e., laser ablation, to a predetermined depth into the corrosion resistant material target 502 and also for repassivating the surface 514 via laser repassivation. The laser pulses 510 can be configured with a Gaussian, flat-top, or other intensity profile, and can be focused or defocused at the surface 514 with beam spot sizes of different diameters and shapes, including circular, elliptical, square, rectangular, etc.

A laser system controller 516 is coupled to the beam delivery system 512 and includes a beam delivery control module 518 configured to control the beam delivery system 512, such as by adjusting galvo scan mirrors, in order to direct the laser pulses 510 to a predetermined location or area of the corrosion resistant material target 502 for laser processing. The laser system controller 516 further includes a laser control module 519 for controlling laser components such as the seed laser 504, pump source 506, and other laser subsystems such as laser drivers or cooling systems (not shown). The laser system controller 516 also includes laser ablation process parameter data 520, laser repassivation process parameter data 522, and laser patterning data 524 in a controller memory 526. The laser system controller 516 also includes one or more processing units 528 situated to receive the data and to determine instructions for sending to other parts of the laser system 500. In typical examples, computer-executable instructions are stored in one or more computer readable storage media, such as magnetic disks or memory, such as random access or read only memory. The laser system controller 516 can select the laser ablation process parameter data 520 or the laser repassivation process parameter data 522 in order to switch operation of the laser system 500 between an ablation mode and a repassivation mode, as well as other modes, depending on the requirements for the laser process and the corrosion resistant material target 502. The laser system controller 516 can be of various types, including one or more FPGAs, PLCs, CPLDs, ASICs, desktop computer, mobile device, etc.

The corrosion resistant material target 502 is mounted on a stage 530 in a normal air environment. In some examples, the stage 530 can be translated relative to the direction of the incident pulses 510 with a stage motor 532 controlled by the laser system controller 516. For example, thicker targets can be raised or lowered, longer targets can be advanced forward, backward, and laterally, or contoured targets can be tilted so that different portions of the same target can become more conveniently aligned with the beam delivery system 512. In further examples, the beam delivery system 512 can be moved, tilted, or adjusted relative to the corrosion resistant material target 502. In representative examples, laser pulses 510 are generated and directed to a selected area of the surface 514 of the target 502 according to the laser patterning data 524 multiple times in order to ablate the selected area to an ablation depth. Using the same laser pattern of the laser patterning data 524, laser pulses 510 with laser repassivation characteristics are generated and directed to the selected area of the target that was ablated in order to repassivate the surface 514 with a corrosion-resistant passivation layer.

FIG. 6 is a set of images of a set of nine engraved samples 600a-600i of 316-alloy stainless steel surfaces that were subsequently laser processed through laser ablation and laser repassivation to become processed samples 602a-602i. The processed samples 602a-602i were then corrosion tested to become corrosion tested samples 604a-604i so as to investigate the quality of the passivation layer formed through laser passivation. The samples 600a-600i had various engraving depths, from about 1 μm to 20 μm.

To produce the processed samples 602a-602i, the samples 600a-600i were each laser processed through laser ablation with a pulsed fiber laser system under ordinary atmospheric conditions (air), increasing the depths of the surface of the samples 600a-600i by different amounts through varied laser ablation process parameters. The pulsed laser beam delivered bursts of pulses to the samples 600a-600i at 200 kHz. The average power of the pulsed laser beam was varied between the samples 600a-600i as well as the number of intra burst pulses in each pulse burst and the number of scan passes of the pulsed laser beam across each sample. The samples 600a-600i were then laser processed with the same pulsed fiber laser system using similar laser ablation process parameters and environmental conditions and also a lower laser pulse energy in order to attempt to repassivate the ablated areas. The average power of the pulsed laser beam for repassivation was between about 0.2 W and 3 W and the number of scan passes of the pulsed laser beam across the samples 600a-600i was between one and five. After repassivation, some of the processed samples 602a-602i showed visible signs of thermal damage, such as the processed samples 602b, 602c, 602e, 602f, 602i which were over-processed. To become the corrosion tested samples 604a-604i, the processed samples 602a-602i were subjected to a liquid soak in a 5% NaCl solution for three days. Visible signs of rust are apparent for the corrosion tested samples 604b-c, 604e-f, 604i which were over-processed by laser ablation. The rust effects bled over into neighboring corrosion tested samples 604a, 604d, 604g, 604h which otherwise exhibited few signs of rust effects or discoloration after corrosion testing.

The processed samples 602a, 602h and corrosion tested samples 604a, 604h were measured for lightness and color using an L*a*b* color space measurement tool and results are shown below in Table 1. The processed sample 602a had an L* value of 69.49, an a* value of 0.91, and a b* value of 0.96 after laser processing, including receiving twenty scan passes of laser ablation pulses at about 7 W of average power removing material to a 5 μm depth. The corrosion tested sample 604a had an L* value of 67.14, an a* value of 0.96, and a b* value of 5.46. The processed sample 602h had an L* value of 68.08, an a* value of 1.2, and a b* value of 6.5 after laser processing, including receiving one hundred scan passes of laser ablation pulses at about 7 W of average power removing material to a depth of 40 μm. The corrosion tested sample 604h had an L* value of 68.77, an a* value of 1.2, and a b* value of 6.42. The lightness and color values of the processed samples 602a, 602h changed by a minimal amount after corrosion testing to become the corrosion tested samples 604a, 604h. Thus, in representative examples, application of laser repassivation pulses associated with laser ablation depths ranging from about 5 μm to about 40 μm can provide suitable laser based passivation effects to laser ablated stainless steel surfaces.

TABLE 1

| | | | | | |
|---|---|---|---|---|---|
| | | | Number | Average | Material |
| | | | of scan | Power | Removal |
| L* | a* | b* | passes | (W) | Depth (μm) |

Sample 1

| | | | | | | |
|---|---|---|---|---|---|---|
| Laser-Processed | 69.49 | 0.91 | 0.96 | 20 | 7 | 5 |
| Corrosion-tested | 67.14 | 0.96 | 5.46 | | | |

Sample 2

| | | | | | | |
|---|---|---|---|---|---|---|
| Laser-Processed | 68.08 | 1.2 | 6.5 | 100 | 7 | 40 |
| Corrosion-tested | 68.77 | 1.2 | 6.42 | | | |

It will be appreciated that various laser process parameters can be changed to increase or enhance laser based repassivation effects. For example, based on laser process parameter selection, passivation layer thickness may be increased or decreased, color variation may be adjusted, and passivation layer stoichiometry may be refined. Furthermore, laser process parameters can be adjusted to correspond to the nature of the process which removes material from the target surface. That is, suitable repassivation pulses can have different pulse process parameters tailored to repassivate mechanically machined surfaces, chemically treated surfaces, as well as surfaces ablated with lasers with variable characteristics, such as wavelength, pulse duration, pulse energy, etc. In further examples, the composition of the alloy target can be altered by increasing or decreasing the percentage of iron or chromium, nickel and other solutes, or by removing or adding solutes, so as to improve the corrosion resistance characteristics of the regrown passivation layer from the laser repassivation pulses. Laser passivation process parameters can be refined by performing controlled statistical experiments on alloy samples. Various conventional specifications can be used to verify laser passivation quality, such as MIL C-161793, MIL PRF-16173, ISO 9227, ASTM B 117, and ASTM D1141-98. Other tests can be performed to verify or gauge laser passivation quality as well, such as L*a*b* chromaticity measurements, or by simply wiping a corrosion tested sample with a white cloth to inspect for rust particulates.

Having described and illustrated the principles of the disclosed technology with reference to the illustrated embodiments, it will be recognized that the illustrated embodiments can be modified in arrangement and detail without departing from such principles. For instance, elements of the illustrated embodiments shown in software may be implemented in hardware and vice-versa. Also, the technologies from any example can be combined with the technologies described in any one or more of the other examples. It will be appreciated that procedures and functions such as those described with reference to the illustrated examples can be implemented in a single hardware or software module, or separate modules can be provided. The particular arrangements above are provided for convenient illustration, and other arrangements can be used.

In view of the many possible embodiments to which the principles of the disclosed technology may be applied, it should be recognized that the illustrated embodiments are only representative examples and should not be taken as limiting the scope of the disclosure. Alternatives specifically addressed in these sections are merely exemplary and do not constitute all possible alternatives to the embodiments described herein. For instance, various components of systems described herein may be combined in function and use. We therefore claim all that comes within the scope and spirit of the appended claims.

We claim:

1. A method, comprising:
generating at least one laser passivation pulse with process parameters selected to passivate an area of a metal target; and
directing the at least one laser passivation pulse to the area in order to produce a passivation layer.

2. The method of claim 1, further comprising:
prior to directing the at least one laser passivation pulse to the area, generating at least one laser ablation pulse with process parameters selected to ablate metal from the area; and
directing the at least one laser ablation pulse to the area so as to ablate the metal and to provide the area for laser passivation. 15

3. The method of claim 1, further comprising chemically passivating the area.

4. The method of claim 1, wherein the selected process parameters of the at least one laser passivation pulse include a pulse duration greater than or equal to 1 ps and less than or equal to 1000 ps.

5. The method of claim 4, wherein the at least one laser passivation pulse includes a plurality of pulses forming a pulsed laser beam having an average power greater than or equal to 0.2 W and less than or equal to 3 W.

6. The method of claim 1, wherein the at least one laser passivation pulse includes one or more pulse bursts having a laser passivation pulse burst repetition rate, each pulse burst including a plurality of laser passivation pulses having an associated intra pulse burst repetition rate.

7. The method of claim 6 wherein the laser passivation pulse burst repetition rate is between about 10 kHz and 500 kHz and the intra pulse burst repetition rate is between about 100 MHz and 1 GHz.

8. The method of claim 2, wherein the selected process parameters of the at least one laser ablation pulse include a pulse duration greater than or equal to 1 ps and less than or equal to 1000 ps.

9. The method of claim 2, wherein the selected process parameters of the at least one laser ablation pulse and the at least one laser passivation pulse include a common pulse duration and pulse repetition frequency.

10. The method of claim 2, wherein the at least one laser ablation pulse includes one or more pulse bursts, and a plurality of such pulse bursts is associated with a laser ablation pulse burst repetition rate, each laser ablation pulse burst including a plurality of laser ablation pulses having an associated intra pulse burst repetition rate.

11. The method of claim 10, wherein the laser ablation pulse burst repetition rate is between about 10 kHz and 500 kHz and the intra pulse burst repetition rate is between about 100 MHz and 1 GHz.

12. The method of claim 2, wherein L, a*, and b* chromaticity values in the area change by less than or equal to 10% from laser ablation to after laser passivation and exposure to a corrosive environment.

13. The method of claim 2, wherein the at least one laser ablation pulse removes metal from the area to a depth of greater than or equal to 10 μm and less than or equal to 100 μm.

14. The method of claim 1, wherein directing the at least one laser passivation pulse to the area includes scanning multiple laser passivation pulses along a path.

15. A method, comprising:
generating at least one laser ablation pulse with process parameters selected to remove stainless steel;
directing the at least one laser ablation pulse to an area of a target surface;
generating at least one laser repassivation pulse with process parameters selected to repassivate the area of the target surface where stainless steel was removed by the at least one laser ablation pulse so as to inhibit corrosion on the area of the target surface; and
directing the at least one laser repassivation pulse to the area of the target surface.

16. An apparatus, comprising:
a pulsed fiber laser situated to generate stainless steel laser ablation process pulses in an ablation mode and to generate stainless steel laser repassivation process pulses in a repassivation mode, the pulsed fiber laser including:
a seed laser,
an active fiber situated to receive optical pulses from the seed laser,
a pump source coupled to the active fiber so as to deliver pump optical radiation to the active fiber to produce optical gain, and
a pulse controller coupled to the seed laser and pump source to switch laser process parameters corresponding to the ablation or repassivation modes.

17. The apparatus of claim 16, wherein the laser process parameters of the ablation and repassivation modes vary according to the material composition of a stainless steel alloy target receiving the corresponding laser pulses.

18. The apparatus of claim 16, wherein the ablation mode and repassivation mode laser process parameters include a pulse duration greater than or equal to 1 ps and less than or equal to 1000 ps.

19. The apparatus of claim 16, wherein the repassivation mode laser process parameters of the laser repassivation pulses include pulsed laser beam average power of less than or equal to 5 W.

20. The apparatus of claim 16, further comprising a galvo-scanner situated to scan the ablation mode pulses and repassivation mode pulses across a stainless steel target.

21. The apparatus of claim 16, wherein the pulses associated with the ablation mode include a series of pulse bursts at a pulse burst repetition rate, each pulse burst including a plurality of laser ablation pulses having an intra pulse burst repetition rate greater than or equal to 100 MHz and less than or equal to 1 GHz.

22. An object produced by the method of claim 2, comprising:
a stainless steel bulk layer having laser ablated surface features; and
a laser repassivation layer situated on the laser ablated surface features.
